(19) United States
(12) Patent Application Publication
(10) Pub. No.: US 2004/0095500 A1
(43) Pub. Date: May 20, 2004

(54) Mobile terminal device having camera function

(76) Inventors: Takeshi Sato, Kanagawa (JP); Kanta Jyudai, Kanagawa (JP); Kazuaki Takamori, Tokyo (JP); Takeshi Nagane, Miyagi (JP); Toshiaki Saitoh, Miyagi (JP); Kazunori Sato, Kanagawa (JP)

Correspondence Address: PEARNE & GORDON LLP, 1801 EAST 9TH STREET, SUITE 1200, CLEVELAND, OH, 44114-3108, US

(21) Appl. No.: 10/472,307

(22) PCT Filed: Feb. 25, 2002
(86) PCT No.: PCT/JP02/01665

(30) Foreign Application Priority Data
Mar. 19, 2001 (JP) 2001-7859

(51) Int. Cl. H04N 5/225

(52) U.S. Cl. 348/340

(57) ABSTRACT

A mobile terminal device having a camera function and comprising a casing of reduced size, in which the arrangement of the functional components other than a camera unit is not restricted by the camera unit. The mobile terminal device (1) comprises a casing (2) having a liquid crystal display unit (15) on its surface (6) and camera unit (16) housed in a camera housing (17) provided on the right side face (7) of the terminal casing (2) in such a way that it can emerge/hide parallel with the casing surface (6) from/into the camera housing (17). The imaging lens section of the camera unit (16) is arranged on the side face of a rotary member (21) protruding from the camera housing (17). The rotary member (21) can rotate around the axis of protrusion with respect to a slide member (20) so as to adjust the imaging direction of the imaging lens unit of a camera body (53).

### TECHNICAL FIELD

The present invention relates to a portable terminal device having a camera function and more particularly to an attachment structure of a camera unit to be attached to a terminal housing.

### BACKGROUND ART

In recent years, there has been proposed a portable terminal device having a camera function in which a camera unit having a built-in CCD camera is attached to a portable terminal device such as a cell phone or a PHS (personal handy phone) and image information as well as voice information can be transmitted and received.

In such a portable terminal device having a camera function, it is necessary to efficiently arrange functional components, for example, a speaker and a microphone for transmitting and receiving voice information, input means (a numeric key, a function key, a cursor key) for carrying out an operation such as information selection or function selection, video display means (a liquid crystal display) for transmitting and receiving image information, a camera unit, a battery and an antenna in the limited space of a terminal housing.

In particular, it is necessary to provide a camera unit on the housing surface of the terminal housing in addition to the functional components such as a speaker, a microphone, a numeric key, a functional key, a cursor key and a liquid crystal display. In the liquid crystal display, the size of a screen tends to be increased due to an increase in image information and an enhancement in a visibility and a reduction in the size of the input means such as the numeric key is also limited.

On the other hand, when such a portable terminal device having a camera function is to be used, an object might be often present on the back side of a terminal housing such as the forward landscape of an operator in addition to the front side of the terminal housing such as the operator.

For example, therefore, there has been proposed a portable terminal device having a camera function in which the imaging lens of a camera unit is turned toward a desired object in such a manner that an operator can carry out the operation of the camera while confirming the object through a liquid crystal display as in “a video camera integrated with a cell phone” and “a cell phone having a television telephone function” which have been disclosed in JP-A-8-294030 and JP-A-10-65780, for example.

For example, in “a video camera integrated with a cell phone” disclosed in the JP-A-8-294030, a camera housing (a camera unit) is fitted and provided rotatably in a concave portion formed on a center in the upper edge portion of a housing body (a terminal housing).

When an object present on the front side of the housing is to be photographed, the camera housing is rotated in such a manner that the imaging lens of a camera head portion provided on one surface of the camera housing is turned toward the front of the housing. When an object present on the back side of the housing is to be photographed, moreover, the camera housing is rotated in such a manner that the imaging lens of the camera head portion is turned toward the back of the housing.

In “a cell phone having a television telephone function” disclosed in the JP-A-10-65780, furthermore, a video camera portion is provided rotatably in a rotating shaft support portion which connects the end of a first housing portion and that of a second housing portion to each other to be relatively rotatable, and furthermore, a notch for permitting the rotation of the video camera portion is provided in at least one of the first and second housing portions.

In a state in which the first and second housing portions are opened, the video camera portion can take a state of facing photographing in which the operator himself (herself) is set to be an object and a state in which the object opposed to the operator is photographed.

As in the conventional portable terminal device having a camera function disclosed in the JP-A-8-294030 and the JP-A-10-65780, in the structure in which the camera unit is rotatably attached to the terminal housing, the camera unit is to be provided on the housing surface of the terminal housing (including the housing surface in a state in which the first and second foldable housing portions are opened) in use.

Therefore, there is a problem in that the camera unit greatly restricts positions in which other functional components are to be provided and the size of the terminal housing is increased.

Accordingly, it is an object of the invention to solve the problems and to provide a portable terminal device having a camera function in which a camera unit does not greatly restrict positions in which other functional components are to be provided but the size of a terminal housing can be reduced.

### DISCLOSURE OF THE INVENTION

The object of the invention can be attained by a portable terminal device having a camera function comprising a terminal housing including video display means on a housing surface and a camera unit accommodated in a camera housing portion provided on a housing side surface of the terminal housing and caused to freely appear from the camera housing portion in parallel along the housing surface,

wherein an imaging lens portion of the camera unit is provided on a side surface of the camera unit which is protruded from the camera housing portion, and the camera unit is rotatable around an axial center in a direction of protrusion in order to adjust an imaging direction of the imaging lens portion.

According to the structure, the camera unit is accommodated in the camera housing portion provided on the housing side surface of the terminal housing and can appear freely, and is not provided on the housing surface. Therefore, positions in which other functional components are to be provided on the housing surface are not greatly restricted. Furthermore, the camera unit can be accommodated in the camera housing portion when the camera is not used. Consequently, it is possible to protect a camera body provided in the camera unit from inadvertent external force.

Moreover, the camera unit protruded from the camera housing portion can be rotated in order to adjust the imaging direction of the imaging lens portion provided on the side surface of the camera unit. Consequently, an operator can carry out the operation of a camera while confirming a desirable object through the video display means.

It is preferable that the camera housing portion should be provided on a housing back side of other functional components disposed on the housing surface side.

Although the camera unit is provided, therefore, the external shape of the terminal housing can be more reduced as seen from the front as compared with that in the related art.

Moreover, it is preferable that the camera unit should include a slide member to be slidably attached into the camera housing portion of the terminal housing and a rotating member having a camera body provided therein and supported on the slide member pivotally and rotatably.

Consequently, it is possible to smoothly carry out an operation for taking the camera unit in/out of the camera housing portion and an operation for adjusting the imaging direction.

### BRIEF DESCRIPTION OF THE DRAWINGS

FIG. 1 is a general perspective view showing a portable terminal device having a camera function according to an embodiment of the invention.

FIG. 2 is an exploded perspective view showing the portable terminal device having a camera function illustrated in FIG. 1.

FIG. 3 is an exploded perspective view showing a camera unit illustrated in FIG. 2.

FIG. 4 is an enlarged plan view showing the main part of the portable terminal device having a camera function illustrated in FIG. 1.

FIG. 5 is a sectional view taken along a line V-V in FIG. 4.

FIG. 6 is a sectional view taken along a line VI-VI in FIG. 4.

FIG. 7 is a partial sectional view showing a state in which the camera unit is accommodated in a camera housing portion illustrated in FIG. 4.

FIG. 8 is a sectional view taken along a line VIII-VIII in FIG. 7.

FIG. 9 is a sectional view taken along a line IX-IX in FIG. 7.

FIG. 10 is an enlarged side view showing the main part of the portable terminal device having a camera function illustrated in FIG. 1.

FIG. 11 is a sectional view taken along a line XI-XI in FIG. 10.

FIG. 12 is a partial sectional view showing a state in which the camera unit is protruded from the camera housing portion illustrated in FIG. 7.

FIG. 13 is a sectional view taken along a line XIII-XIII in FIG. 12.

FIG. 14 is a rear view showing the portable terminal device having a camera function illustrated in FIG. 1.

FIG. 15 is a rear view showing a portable terminal device having a camera function according to another embodiment of the invention.

In the drawings, 1 denotes a portable terminal device having a camera function, 2 denotes a terminal housing, 6 denotes a housing surface, 7 denotes a housing right side surface (a housing side surface), 15 denotes a liquid crystal display portion (video display means), 16 denotes a camera unit, 17 denotes a camera housing portion, 20 denotes a slide member and 21 denotes a rotating member.

### BEST MODE FOR CARRYING OUT THE INVENTION

A portable terminal device having a camera function according to an embodiment of the invention will be described below in detail with reference to the accompanying drawings.

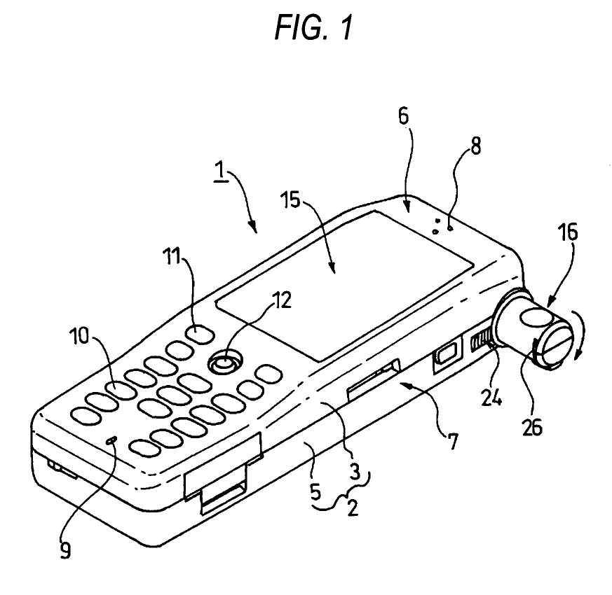

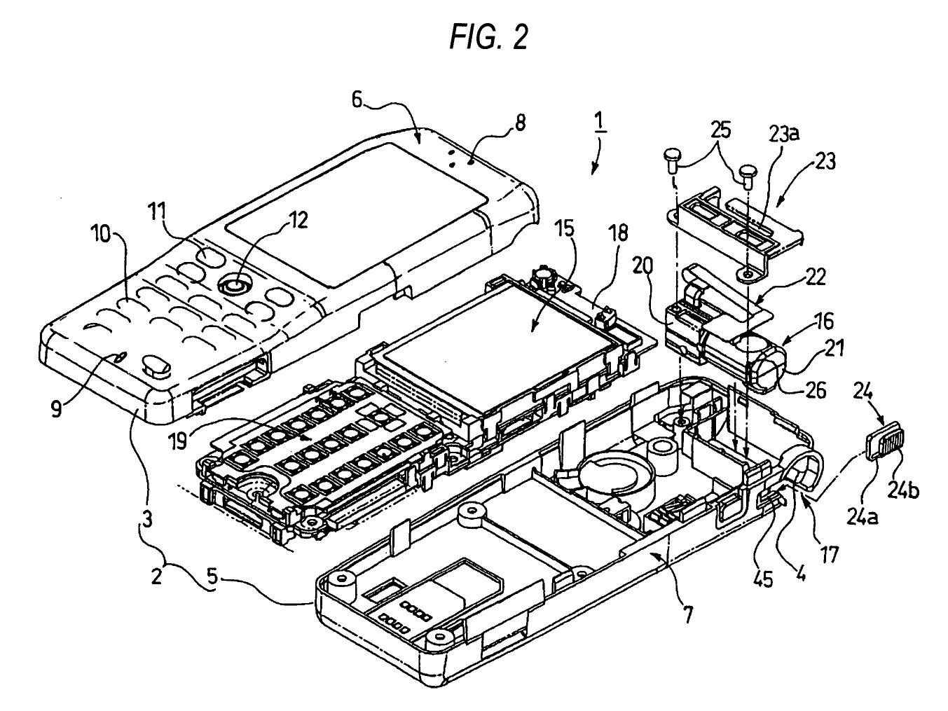

A portable terminal device 1 having a camera function according to the embodiment comprises a terminal housing 2 taking the shape of an almost rectangular parallelepiped which includes a case body 5 and a cover 3, a printed circuit board unit 19 to be mounted in the terminal housing 2, and a camera unit 16 as shown in FIGS. 1 and 2.

As shown in FIG. 1, a housing surface 6 of the terminal housing 2 is provided with a speaker portion 8 and a microphone portion 9 for transmitting and receiving voice information, a numeric key 10 to be input means, a function key 11 and a cursor key 12, and a liquid crystal display portion 15 to be video display means. Moreover, the camera unit 16 to be accommodated in a camera housing portion 17 which will be described below is provided in the upper part of a housing right side surface 7 of the terminal housing 2.

The printed circuit board unit 19 has the liquid crystal display portion 15, the input means unit and a control circuit unit previously mounted integrally with a body board 18 as shown in FIG. 2.

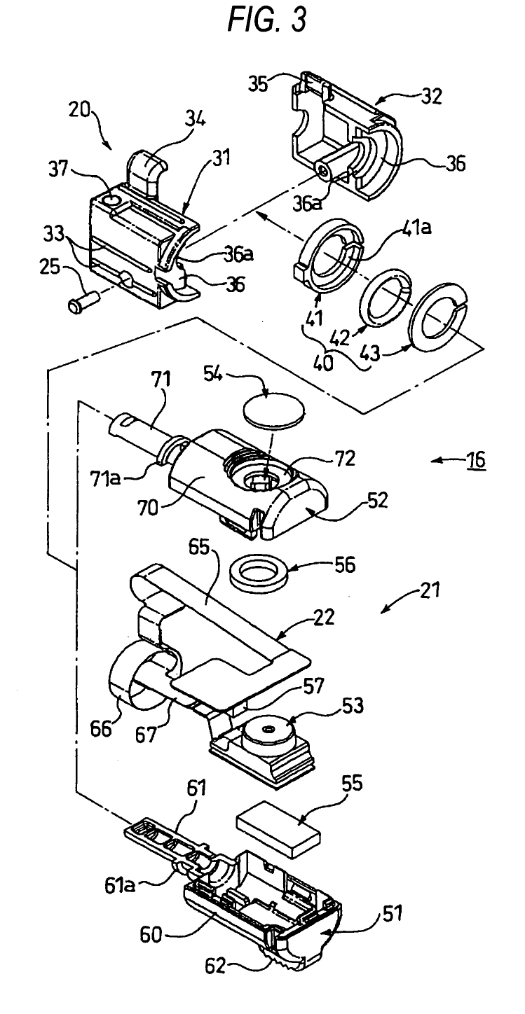

As shown in FIG. 3, the camera unit 16 includes a slide member 20 attached slidably into the camera housing portion 17 of the terminal housing 2, and a rotating member 21 having a camera body 53 provided therein and pivotally supported rotatably on the slide member 20.

The rotating member 21 has a camera case 51 and a camera cover 52 which have structures obtained by vertically dividing an almost cylindrical case into two parts.

The camera case 51 has a case portion 60 for holding and fixing the camera body 53 through a cushion member 55, a small shaft portion 61 extended on one end side of the case portion 60 and pivotally supported rotatably on the slide member 20, and a finger catching portion 62 provided on an outer peripheral surface at the other end side of the case portion 60.

The camera cover 52 has a case portion 70 for holding and fixing the camera body 53 through a cushion member 56, a small shaft portion 71 extended on one end side of the case portion 70 and pivotally supported rotatably on the slide member 20, and a window portion 72 provided on the outer peripheral surface of the case portion 70 and attaching a lens cover 54 thereto.

One of the ends of an FPC (flexible printed circuit) 22 is connected to the camera body 53.

The FPC 22 extended from the camera body 53 has an extended portion 67 extended to be interposed between the small shaft portions 61 and 71 of the camera case 51 and the camera cover 52 which are assembled, a spiral portion 66 extended from the tip of the extended portion 67 outward in the radial direction of the small shaft portions 61 and 71 and wound with a looseness around the small shaft portions 61 and 71, and an extra extended portion 65 extended with a U-shaped looseness from the tip of the spiral portion 66, and has the other end connected to the body board 18 through a connector 57.

The slide member 20 includes slide cases 31 and 32 having a structure obtained by vertically dividing a case having a rectangular section into two parts. The slide cases 31 and 32 are formed by a POM (polyoxymethylene) resin which is excellent in a sliding property and an abrasion resistance.

The slide cases 31 and 32 have bearing receiving portions 36 formed on one end side in order to pivotally support the small shaft portions 61 and 71 of the rotating member 21 rotatably through a bearing device 40. Moreover, the upper surfaces of the slide cases 31 and 32 are provided with guide portions 34 and 35 for interposing and guiding the tip of the spiral portion 66 in the FPC 22 when the rotating member 21 is assembled into the slide member 20.

Furthermore, a sliding rib 33 for decreasing a sliding resistance during sliding and carrying out positioning for the case body 5 is properly protruded from the outer peripheral surfaces of the slide cases 31 and 32. A hemispherical concave portion 37 formed on the upper surface of the slide case 31 is engaged with stopper pieces 81 and 83 of a slide plate 23 which will be described below, thereby controlling the inadvertent slide of the slide member 20 and obtaining a feeling of a click during a sliding operation.

The bearing device 40 is constituted by a bearing body 41 for pivotally supporting the small shaft portions 61 and 71 of the rotating member 21, a C ring 42 to be an elastic member which is to be inserted into a receiving portion 41a of the bearing body 41, and a spacer 43 interposing the C ring 42 together with the receiving portion 41a.

The bearing device 40 is attached to the small shaft portions 61 and 71 of the rotating member 21 and is then assembled into the slide member 20 together with the rotating member 21 in such a manner that the bearing body 41 is received by the bearing receiving portion 36.

At this time, the slide cases 31 and 32 are assembled in such a manner that inner peripheral ribs 36a of the slide cases 31 and 32 are inserted between flanges 61a and 71a of the small shaft portions 61 and 71 and the bearing body 41, and are fixed with a screw 25.

Consequently, the C ring 42 is compressed and deformed between the rotating member 21 and the slide member 20 in the direction of a shaft center.

A frictional resistance generated by the elastic repulsion force of the C ring 42 is applied to the rotating sliding portion of the rotating member 21 and the slide member 20 so that the inadvertent relative rotation of the rotating member 21 and the slide member 20 can be blocked.

It is possible to eliminate the C ring 42 by previously increasing a frictional resistance during a rotation between the rotating member 21 and the slide member 20 to some degree.

The camera unit 16 constituted by assembling the rotating member 21 to the slide member 20 is attached into the predetermined housing portion of the case body 5 and an upper part thereof is covered with the slide plate 23 as shown in FIG. 2. The slide plate 23 is fixed to the case body 5 with the screw 25 so that the camera unit 16 is positioned in the direction of the thickness of the case body 5.

Moreover, the slide plate 23 is provided with a slit 23a in a sliding direction which prevents the guide portions 34 and 35 for interposing and guiding the FPC 22 above from interfering with each other when the slide member 20 slides.

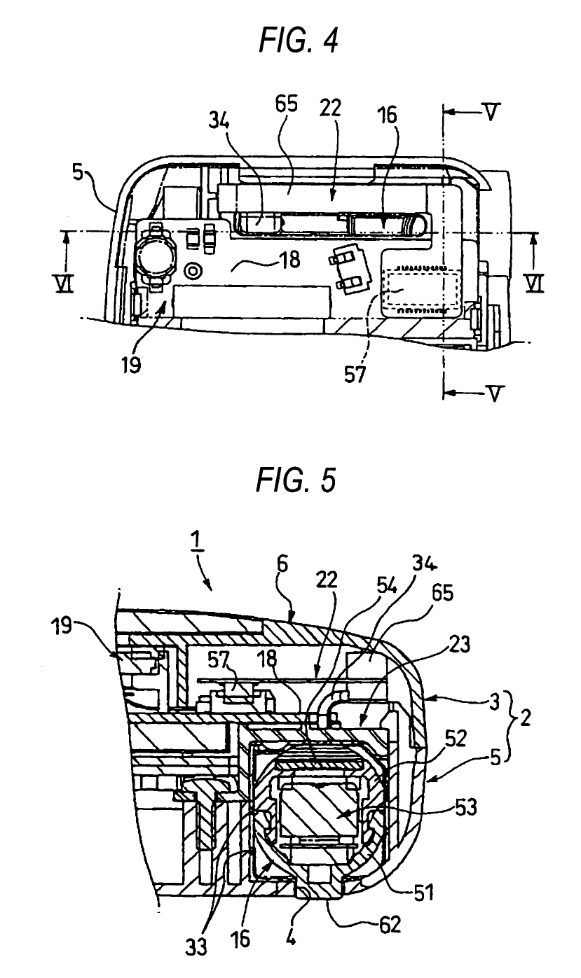

Furthermore, the printed circuit board unit 19 is attached to the case body 5, and the end of the FPC 22 extended from the guide portions 34 and 35 is then connected to the body board 18 through the connector 57 as shown in FIGS. 4 and 5.

The cover 3 is assembled into the cover body 5 so that the assembly of the portable terminal device 1 having a camera function according to the embodiment is completed.

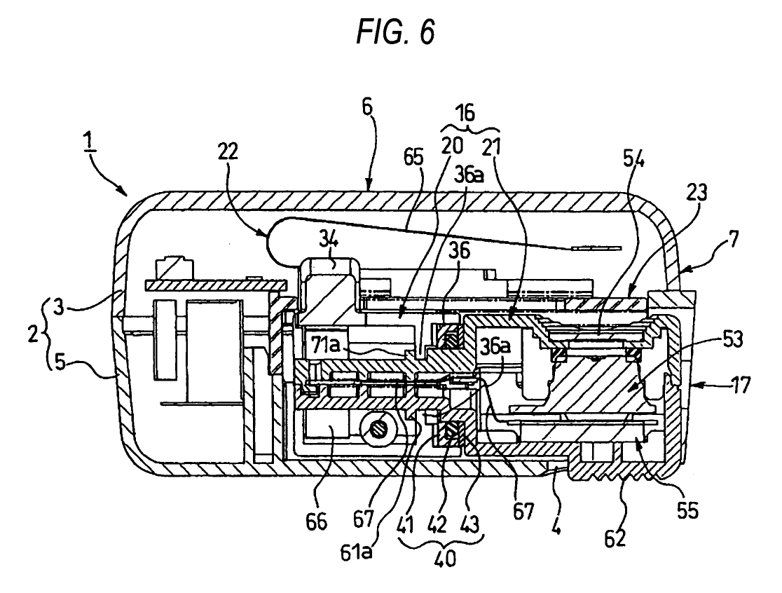

The camera unit 16 of the portable terminal device 1 having a camera function according to the embodiment is accommodated in the camera housing portion 17 partitioned by the internal wall of the case body 5 and the slide plate 23 and provided to be opened to the housing right side surface 7 of the terminal housing 2, and furthermore, the rotating member 21 can freely appear from the housing right side surface 7 in parallel along the housing surface 6 by the slide member 20 attached slidably into the camera housing portion 17 as shown in FIGS. 1, 5 and 6.

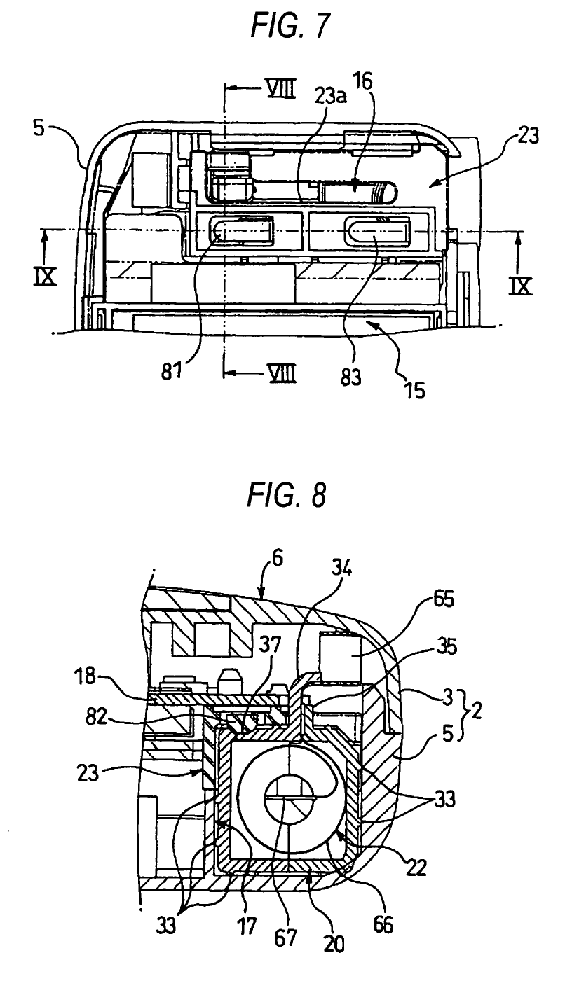

As shown in FIGS. 7 to 9, a hemispherical engagement projection 82 protruded from the tip of the stopper piece 81 formed as a flexible engagement piece on the slide plate 23 is fitted in the hemispherical concave portion 37 provided on the slide member 20 in such a state that the camera unit 16 is accommodated in the camera housing portion 17. In the slide member 20, a motion in a sliding direction is controlled.

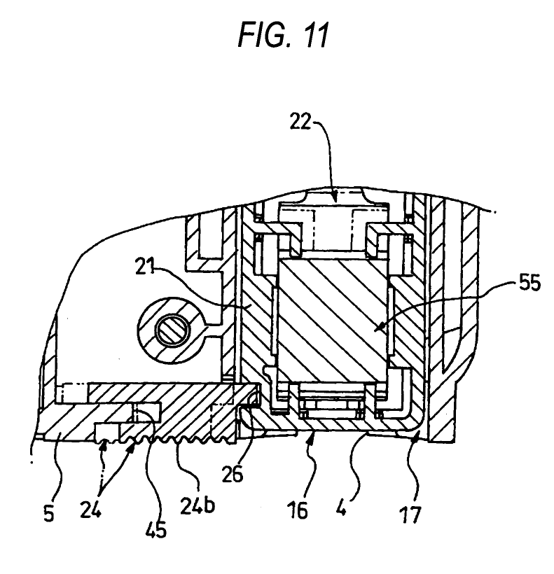

Furthermore, the camera unit 16 is locked so as not to inadvertently jump out of the camera housing portion 17 by means of a slide hook 24 attached to a notch portion 45 formed on the open edge of the camera housing portion 17 as shown in FIGS. 10 and 11.

The slide hook 24 is slidably fitted in the notch portion 45 formed on the right side surface of the case body 5 as shown in FIG. 2, and an elastic stopper 24a provided on a lower edge is engaged with an engagement projection which is not shown, thereby switching a locking position in which a tip protrusion is engaged with an engagement groove 26 formed on the side surface of the tip of the rotating member 21 (a state shown in a solid line of FIG. 11) and an unlocking position in which the tip protrusion is not engaged with the engagement groove 26 (a state shown in a virtual line of FIG. 11). A finger catching portion 24b is formed on the outside surface of the slide hook 24.

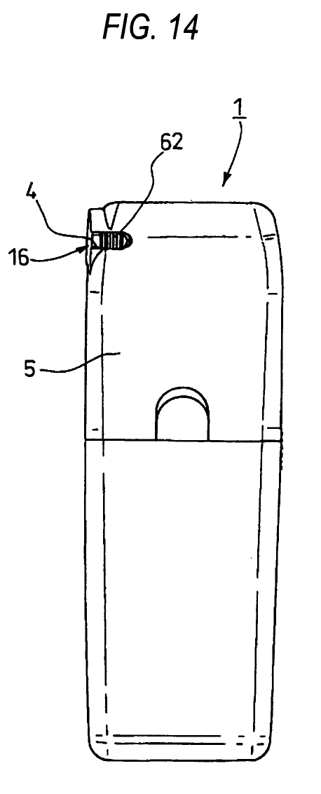

When the camera unit 16 is to be pulled out of the camera housing portion 17, the slide hook 24 is first caused to slide into the unlocking position to carry out unlocking and a fingertip is then put on the finger catching portion 62 of the rotating member 21 exposed from the notch portion 4 formed on the bottom face of the case body 5 to carry out sliding in a pull-out direction as shown in FIG. 14.

At this time, the stopper piece 81 fitted in the hemispherical concave portion 37 of the slide member 20 is elastically deformed so that the fitting of the engagement projection 82 is released. Consequently, an operator can obtain a feeling of a click.

When the camera unit 16 slides in the pull-out direction, the FPC 22 extended from the guide portions 34 and 35 of the slide member 20 can follow the motion of the sliding of the slide member 20 by the flexibility of the extra extended portion 65 extended with a U-shaped looseness.

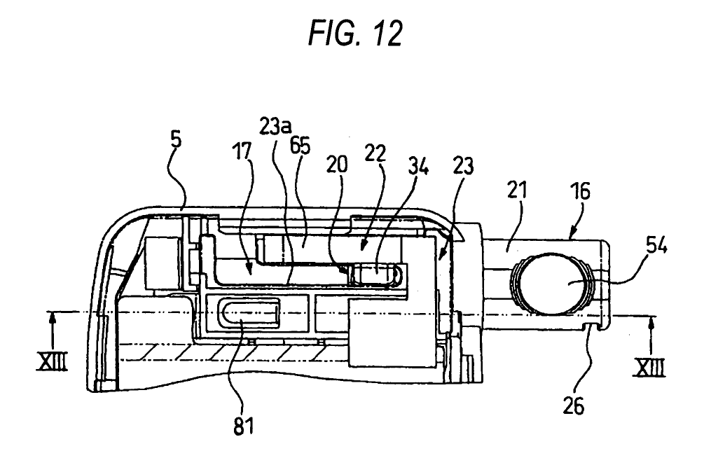

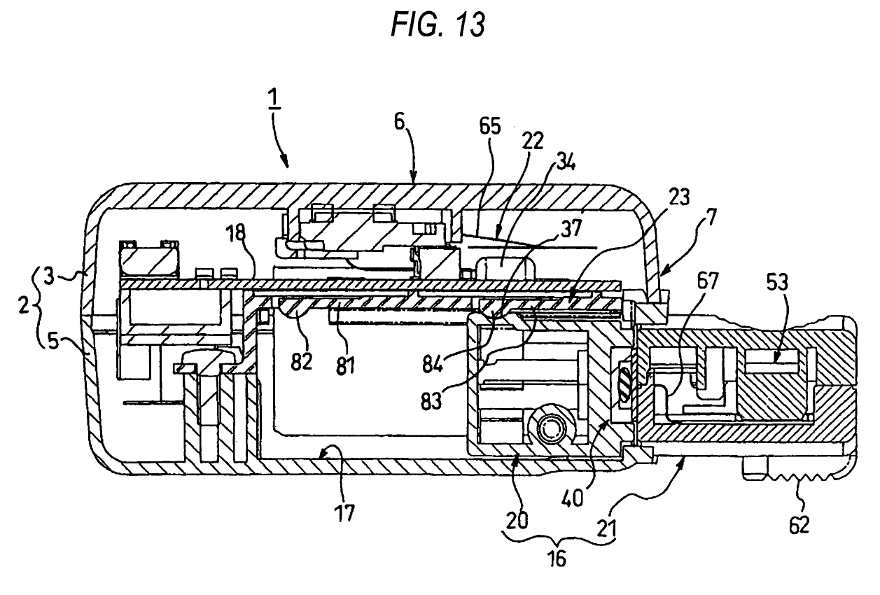

As shown in FIGS. 12 and 13, a hemispherical engagement projection 84 protruded from the tip of the stopper piece 83 formed as a flexible engagement piece on the slide plate 23 is fitted in the hemispherical concave portion 37 provided on the slide member 20 in a state in which the camera unit 16 is completely pulled out of the camera housing portion 17.

The camera unit 16 can be prevented from being inadvertently accommodated in the camera housing portion 17 and an operator can obtain a feeling of a click so that an operability can be enhanced.

Furthermore, the imaging lens portion of the camera unit 16 is provided on the side surface of the rotating member 21 to be a camera unit side surface protruded from the camera housing portion 17 as shown in FIGS. 12 and 13.

The rotating member 21 pivotally supported on the slide member 20 rotatably around a shaft center in the direction of protrusion is properly rotated so that the imaging direction of the imaging lens portion can be optionally adjusted within a range of approximately 180 degrees from the housing front side to the housing back side.

When the rotating member 21 is to be rotated with respect to the slide member 20, the spiral portion 66 to be wound with a looseness around the small shaft portions 61 and 71 is wound and fastened so that the FPC 22 provided between the small shaft portions 61 and 71 of the rotating member 21 and the guide portions 34 and 35 of the slide member 20 can follow the rotation of the rotating member 21.

Moreover, the rotating member 21 is prevented from being inadvertently rotated relatively with the slide member 20 by the action of the bearing device 40, and therefore, can be stopped in an optional rotating position. Thus, the operation for adjusting the imaging direction can be carried out smoothly.

More specifically, according to the portable terminal device 1 having a camera function according to the embodiment, the camera unit 16 is accommodated in the camera housing portion 17 provided on the housing right side surface 7 of the terminal housing 2 and freely appears, and is not provided on the housing surface 6.

Consequently, the positions of arrangement of other functional components provided on the housing surface 6 (the speaker portion 8 and the microphone portion 9, the numeric key 10, the function key 11 and the cursor key 12, and the liquid crystal display portion 15) are not greatly restricted.

Furthermore, since the camera unit 16 is accommodated in the camera housing portion 17 when the camera is not used, the camera body 53 provided in the camera unit 16 can be protected from inadvertent external force.

Moreover, the rotating member 21 of the camera unit 16 protruded from the camera housing portion 17 is rotatable to adjust the imaging direction of the imaging lens portion provided on a side surface. Therefore, an operator can carry out the operation of the camera while confirming a desirable object by means of the liquid crystal display portion 15.

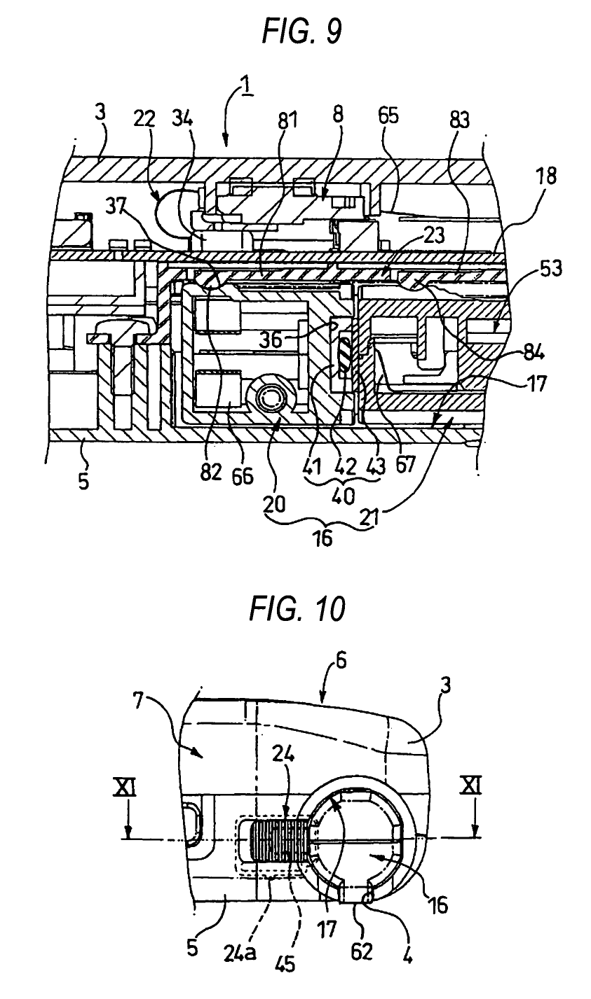

Furthermore, the camera housing portion 17 is provided on the housing back side of the speaker 8 to be another functional component which is disposed on the housing surface 6 side as shown in FIG. 9.

Although the portable terminal device 1 having a camera function comprises the camera unit 16, the external shape of the terminal housing 2 can be more reduced as seen from a front as compared with that in the related art.

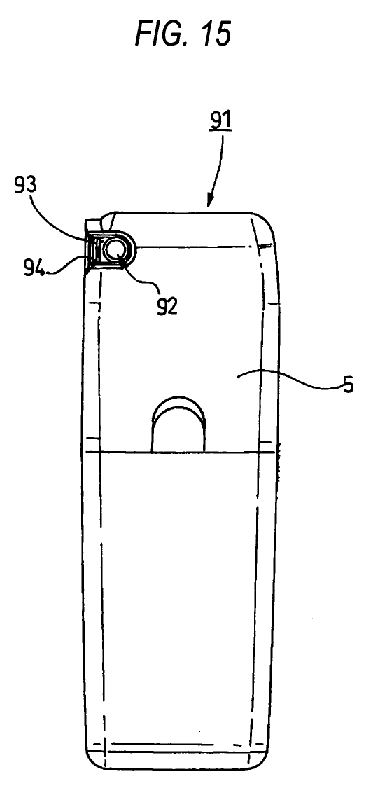

FIG. 15 is a rear view showing a portable terminal device 91 having a camera function according to another embodiment of the invention. Differently from the portable terminal device 1 having a camera function, a camera body 53 provided in a rotating member 92 of a camera unit 16 is provided in an accommodation state in a camera housing portion 17 in such a manner that an imaging lens portion is placed in the same position as the position of a window portion 94 provided on the bottom face of a case body 5, and the imaging lens portion is turned toward the housing back side.

Consequently, an operator can photograph an object provided on the housing back side without pulling out the camera unit 16. When an object (the operator himself (herself)) on the housing front side is to be photographed, moreover, it is preferable that a fingertip should be put on a finger catching portion 93 to carry out sliding in a pull-out direction and the rotating member 92 should be then rotated to turn the imaging lens portion toward the housing front side.

The operator adapts the direction of the imaging lens portion to himself (herself) while watching a liquid crystal display portion 15 of a housing surface 6 in a camera photographing mode in that state and determines a composition to release a shutter, and fetches imaging data into a memory of the body. When the photographing is ended, a reverse operation to the pull-out operation is carried out to accommodate the camera unit 16 in the camera housing portion.

It is apparent that the portable terminal device having a camera function according to the invention is not restricted to the structure of each of the embodiments but can employ various configurations based on the scope of the invention.

For example, it is also possible to employ such a structure that elastic energizing means such as a coiled spring is provided between the case body 5 and a slide member 20 to unlock a slide hook 24 and to cause the camera unit to pop up by spring force.

While the camera housing portion 17 is provided on the housing right side surface 7 of the terminal housing 2 in each of the embodiments, moreover, the invention is not restricted thereto but the camera housing portion can also be provided on the housing left side surface and the upper and lower housing side surfaces of the terminal housing.

While the invention has been described in detail with reference to the specific embodiments, it is apparent to the skilled in the art that various changes and modifications can be made without departing from the spirit and scope of the invention.

The invention is based on Japanese Patent Application (No. 2001-078959) filed on Mar. 19, 2001 and contents thereof are incorporated by reference.

### INDUSTRIAL APPLICABILITY

As described above, according to the portable terminal device having a camera function in accordance with the invention, the camera unit is accommodated in the camera housing portion provided on the housing side surface of the terminal housing and is caused to appear freely, and is not provided on the surface of the housing.

Therefore, the positions of arrangement of other functional components to be provided on the surface of the housing are not restricted greatly and the external shape of the terminal housing can also be more reduced as seen from a front than that in the related art.

Furthermore, the camera unit can be accommodated in the camera housing portion when the camera is not used. Therefore, the camera body provided in the camera unit can be protected from inadvertent external force.

Moreover, the camera unit protruded from the camera housing portion can be rotated in order to adjust the imaging direction of the imaging lens portion provided on the side surface of the camera unit. Therefore, an operator can carry out the operation of the camera while confirming a desirable object through video display means.

Accordingly, it is possible to provide a portable terminal device having a camera function in which a camera unit does not greatly restrict the positions of arrangement of other functional components and the size of a terminal housing can be reduced.

1. A portable terminal device having a camera function comprising a terminal housing including video display means on a housing surface and a camera unit accommodated in a camera housing portion provided on a housing side surface of the terminal housing and caused to freely appear from the camera housing portion in parallel along the housing surface,
wherein an imaging lens portion of the camera unit is provided on a side surface of the camera unit which is protruded from the camera housing portion, and
the camera unit is rotatable around an axial center in a direction of protrusion in order to adjust an imaging direction of the imaging lens portion.

2. The portable terminal device having a camera function according to claim 1,
wherein the camera housing portion is provided on a housing back side of other functional components disposed on the housing surface side.

3. The portable terminal device having a camera function according to claim 2,
wherein the camera unit includes a slide member to be slidably attached into the camera housing portion of the terminal housing and a rotating member having a camera body provided therein and supported on the slide member pivotally and rotatably.
